(19) United States
(12) Patent Application Publication
(10) Pub. No.: US 2014/0304620 A1
(43) Pub. Date: Oct. 9, 2014

(54) CONTENT DRIVEN MOBILE COMMUNICATION SYSTEM

(71) Applicant: MEDCONNECTIONS INC., San Jose, CA (US)

(72) Inventors: Chuandong Xu, San Jose, CA (US); Wenwu Cui, Cupertino, CA (US); Yu Shao, Germantown, MD (US); Chuanxi Xu, Wuhan (CN)

(73) Assignee: MEDCONNECTIONS INC., San Jose, CA (US)

(21) Appl. No.: 13/858,827

(22) Filed: Apr. 8, 2013

(51) Int. Cl. H04L 29/08; G06F 3/0484

(52) U.S. Cl. CPC H04L 67/26; G06F 3/04842
USPC 715/753

(57) ABSTRACT

Provided is a computing device or a computer-implemented method for generating a user interface to retrieve user input. The computer device is configured to retrieve a question and expected answer from a question database; determine a question format based on the content of the question and the expected answer, wherein the question format is selected from the group consisting of (a) a question requiring a text input, (b) a polar question, (c) a multiple choice question with a single choice, (d) a multiple choice question with one or more choices, and (e) a referral question that loads a selected computer program; select a predefined user interface based on the determined question format; display the question with the selected user interface on a screen; and receive an input from a user as answer to the question.

### BACKGROUND

Traditional communication channels between consumers and service providers involve phone calls, interactive voice responses (IVR), short message service (SMS), emails, snail mails, providers' websites, etc. Phone call and IVR usually provide good interactive communication. These methods, however, are labor intensive and thus are expensive. Further, these traditional methods are difficult to automate and customize. SMS, email, and IVR are quicker but still are not efficient because they are difficult to scale up and lack of real-time interactivity.

Presently, smart phones and other internet ready mobile devices are commonly used in our daily life. This allows service providers to reach consumers via a new communication channel with, for instance, push notifications to mobile devices. Push notification is similar to SMS, but has several advantages.

First, a push notification supports longer message than SMS does. SMS is typically limited to 140 bytes of text. Push notification, by contrast, supports 256 bytes on iOS and 1024 bytes on Android systems. Further, push notifications do not require a phone number, so more mobile devices can be reached. Moreover, push notifications can prompt for and receive a response from a user to initiate a smart phone app or a mobile web browser that enables provision of more information.

Nevertheless, push notification is still a one-way communication, and does not enable interactive communication between service providers and consumers.

### SUMMARY

One embodiment of the present disclosure provides a computing device comprising a processor and program code which, when executed by the processor, configures the device to: retrieve a question and expected answer from a question database; determine a question format based on the content of the question and the expected answer, wherein the question format is selected from the group consisting of (a) a question requiring a text input, (b) a polar question, (c) a multiple choice question with a single choice, (d) a multiple choice question with one or more choices, and (e) a referral question that loads a selected computer program; select a predefined user interface based on the determined question format; display the question with the selected user interface on a screen; and receive an input from a user as answer to the question.

In some embodiments, the selected user interface comprises a text input area if the determined question format is (a), the selected user interface comprises a button for a positive answer and a button for a negative answer if the determined question format is (b), the selected user interface comprises a button for each of the choices if the determined question format is (c), the selected user interface comprises a checkbox for each of the choices and a confirmation button if the determined question format is (d), or the selected user interface comprises one or more referral link if the determined question format is (e). The referral links, in some embodiments, each is directed to a program selected from the group consisting of voice call to a phone number, a web address, a multimedia file, a navigation or mapping program, and a social networking program.

In some embodiments, the selection of a predefined user interface further takes into consideration of the user's information selected from one or more of age, gender, locale, healthcare or condition.

In some embodiments, following determination of the question format, the system is further configured to generate a tag for the question that corresponds to the question format or corresponds to the selected user interface. In some embodiments, the system is further configured to store the tag.

In some embodiments, the generation of the tag is before, or after, the selection of the user interface. When the generation of the tag is before the selection of the user interface, the selection of the user interface can be based on the tag.

In some embodiments, the program code further configures the device to, prior to displaying the question on the screen, send an alert to the user, wherein the alert prompts the user to receive the question. In some embodiments, the program code further configures the device to terminate the computer process on the device for displaying the question and receiving the input. In some embodiments, the program code further configures the device to reinitiate a computer process, upon the user's response to receive the question, to display the question and receive the input from the user.

Computer-implemented methods and non-transitory computer medium comprising program code for carrying out these methods are also provided. In one embodiment, provided is a method for conducting a survey, comprising: retrieving, on a computing device, a question and expected answer from a question database; determining a question format based on the content of the question and the expected answer, wherein the question format is selected from the group consisting of (a) a question requiring a text input, (b) a polar question, (c) a multiple choice question with a single choice, (d) a multiple choice question with one or more choices, and (e) a referral question that loads a selected computer program; selecting a predefined user interface based on the determined question format; displaying the question with the selected user interface on a screen; and receiving an input from a user as answer to the question.

### BRIEF DESCRIPTION OF THE DRAWINGS

Provided embodiments are illustrated by way of example, and not limitation, in the figures of the accompanying drawings in which:

FIG. 1 illustrates representative components of a business process driven communication system of one embodiment of the disclosure;

FIG. 2 illustrates a notification process workflow; and

FIG. 3 provides more details of the illustrated notification process workflow.

It will be recognized that some or all of the figures are schematic representations for purposes of illustration and do not necessarily depict the actual relative sizes or locations of the elements shown. The figures are provided for the purpose of illustrating one or more embodiments with the explicit understanding that they will not be used to limit the scope or the meaning of the claims.

### DETAILED DESCRIPTION OF THE DISCLOSURE

As used herein, certain terms have the following defined meanings. Terms that are not defined have their art recognized meanings.

As used in the specification and claims, the singular form “a”, “an” and “the” include plural references unless the context clearly dictates otherwise.

As used herein, the term “comprising” is intended to mean that the components, systems and methods include the recited elements, but not excluding others. “Consisting essentially of” when used to define components, systems and methods, shall mean excluding other elements that would materially affect the basic and novel characteristics of the disclosure. “Consisting of” shall mean excluding any element, step, or component not specified in the claim. Embodiments defined by each of these transition terms are within the scope of this disclosure.

The present disclosure provides systems and methods that provide an interactive information exchange between a service provider, such as a custom service provider and healthcare service provider, and a customer. The presentation and the interaction can be dynamically generated by the system, depending on the content with which the service provider chooses to initiate the communication.

For instance, the service provider wants to conduct a survey with its customers. The provider can then configure the system to select survey questions from a question database and present the questions to the customers. In another example, if a healthcare service provider needs to follow up with a patient to ensure medication compliance or check health condition of the patient, then the healthcare service provider can configure the system to choose a number of appropriate questions to inquire about the status of the patient. In this context, the questions are the “contents” that are used to initiate a communication with the customer.

### Content Driven Communication System

Rather than requiring the service provider to generate, de novo, a user interface to fit their selected contents or configure a generic user interface for its particular use, the present disclosure provides a system that automatically determines or configures a user interface and related communication process based on the selected content.

In some embodiments, in a first step, the system of the present disclosure selects a question, and its expected answer(s) or type of answers. The selection can be manually made, but can also be predetermined by the provider. The predetermination, in this respect, can be made based on a user profile or the service provider's goal. For instance, for a patient who recently underwent a surgical operation, the question can be related to schedule of taking pain relief medication for any discomfort suffered by the patient. Likewise, for a customer service provider that is set out to identify satisfaction with a new product, the question can relate to the customers' experience with the product.

Upon selection of the communication content (e.g., the question), the system determines the type of the content (e.g., question format), selects, from a set of predefined user interfaces, one that fits the content type, presents the content with the selected user interface, and further interacts with a user through the user interface. The details of this process are provided below, with reference to related figures.

### Determination of Question Format

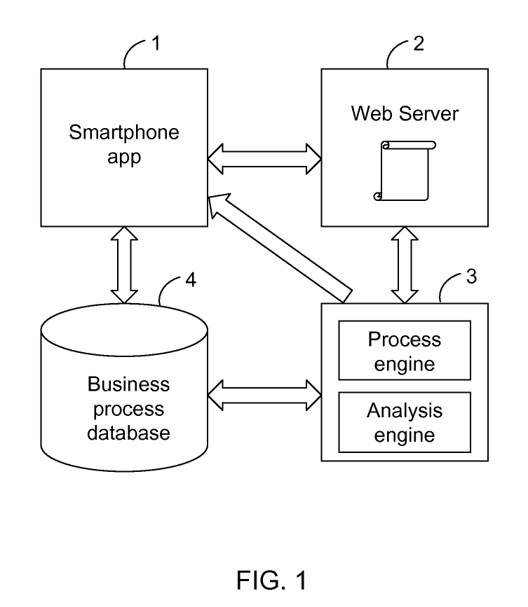

As shown in FIG. 1, in one embodiment, in a first step, the system retrieves a question from a question database (shown as business process database 4). It is to be understood that the database does not have to reside on the same computing device as the device that executes the program code that directs the overall process of the present disclosure, such as where the process engine and/or the analysis engine is located. Upon retrieval of the question, the system feeds the question into a “process engine” that analyzes the question to determine the question format.

In some embodiments, the question format is selected from a predefined set of question formats. Table 1 below, in column 1, provides a list of non-limiting examples of such predefined question formats. Determination of the question format, a processed carried out by the process engine of the present technology, can be carried out with various methods. For instance, text-based pattern recognition methods can be used to determine the format of the question.

In some embodiments, the process engine can coordinate interactions between users and software systems, using a workflow engine. A workflow engine coordinates the flow and interactions across manual and automated tasks. The process engine can also support business rule management, business events, user and group collaboration, without limitation.

The content driven mobile communication system of the present disclosure can enable business rule management, user interaction, and process automation and orchestration. In this respect, it requires a business process management engine instead of a pure workflow engine. The business process management platform of Activiti (activiti.org), for instance, can be used as the business process management engine. Activiti provides tools for business rule design, process management, and user management. It can also be extended to add an analysis engine for additional data analysis and intelligence.

TABLE 1
Matching User Interface with Question Formats

| No. | Question Format | User Interface |
|---|---|---|
| a | Question requiring a text | Text input area with a confirmation |
| | input | button |
| b | A polar (yes/no) question | Positive (Yes) and negative (No) |
| | | response buttons |
| c | A multiple choice question | A button for each choice |
| | with single answer | |
| d | A multiple choice multi- | Multiple checkboxes with a |
| | select question | confirmation button |
| e | A referral question that | Referral links for loading the program |
| | redirects user to a | (e.g., url in browser, starting multi- |
| | program (e.g., url, multi- | media, calling a phone number |
| | media, phone numbers or to | if phone feature is available, |
| | load an app or app feature) | loading a feature in an |
| | | app, or starting another app |
| | | (e.g., navigation software, |
| | | address book) |

### Selection of a Predefined User Interface

Once the question format for a selected question is determined, a suitable user interface can be selected to present the question. Therefore, the system does not require generation of a new user interface for each question or question formation. For instance, whether a multiple choice question has three or ten choices to choose from, a predefined multiple choice user interface can used, which automatically scales up or down, with the correct number of buttons or checkboxes to suit the need of the question.

More specifically, in one embodiment, the system automatically selects a user interface that contains a text input area if the determined question format is (a), a question requiring a text input. In some embodiments, the system automatically determines the location and/or size of the text input area. For instance, the system examines the question and/or the expected answer and predicts the size of the answer.

For a mobile device, the determination can further include the type of the text, e.g., text or numerical. For a numerical answer, for instance, the system can provide a text input area that prompts input of digit. Such a selection, therefore, can automatically load a number pad, rather than an alphabetical keyboard, for the user's convenience. In some aspects, the interface also includes a button for a user to click once the text input is complete. In some aspects, the button is not required or is not required to be clicked, since an “enter” key can automatically complete the answer. Still, in some aspects, the text input has an expected length, and once the input reaches that length, the system automatically completes the input and retrieves the answer.

In another embodiment, if the determined question format is (b), a polar question, the system automatically selects a user interface that includes a button for a positive answer and a button for a negative answer. A polar question is typically a question that requires a yes or no answer. In some instances, however, a polar question may simply require a confirmation that a message has been read. In this situation, the selected interface can include just one button.

In yet another embodiment, if the determined question format is (c), a multiple choice question with single answer, then the system automatically selects a user interface that includes a button for each of the choices. When a user click on any of the button, an answer is retrieved by the system. In some aspects, each of the answer is associated with a checkbox, and further a confirmation button is included. The confirmation button can be used to confirm a user's choice after a checkbox is checked.

In any of the above embodiments, it is to be understood that a “button” is a generic term that describes a visual signal on an electronic screen which detects a motion of a human gesture input, either directly by fingers or other physical object on the screen, or through a human interference device, such as a mouse. The feel and look of a button and a checkbox can vary. For instance, a dropdown menu can be used instead of a conventional menu listing all choice, each with a checkbox adjacent to the choice.

In one embodiment, if the determined question format is (d), a multiple choice multi-select question, the system automatically selects a user interface that includes a checkbox for each of the choices and a confirmation button.

In one embodiment, if the determined question format is (e), a referral question that redirects user to a program (e.g., url, multi-media, phone numbers or to load an app or app feature), the selected user interface includes one or more referral links. In some aspects, the referral links each is directed to a program selected from the group consisting of voice call to a phone number, a web address, a multimedia file, a navigation or mapping program, and a social networking program.

In some embodiment, one any one or more of the interfaces, a button can be further includes that enables a user to inform the system that a voice answer is going to be provided. Still, in some embodiments, such a button is not provided, instead, the system monitors voices around the end user's device. When a recognizable voice command is detected, the system automatically loads a speech reorganization process to receive and process a voice answer.

In some embodiments, the system automatically selects or optimizes the user interface based on any of the following information, type of end user device, type of operating system of the device, information about the user, such as the user's age, gender, profession, locale, social status, purchase history, health condition, without limitation. Such information can be provided by the user or retrieved, with the user's permission, from a profile database that is stored in the user's device or a separate database, such as medical record database.

For instance, if the user is elderly, the system can automatically enlarge the fonts on the user interface. Likewise, if the user is minor, a kids-friendly interface is provided. Suitable color scheme or theme can be tailored for different genders. Based on the user's locale or language preference, the user interface can be automatically displayed in the preferred language or time zone.

In some embodiment, selection of the user interface can take other information into consideration. In one aspect, each question in the question database is associated with a “tag” that helps determine the format of the question and/or the preferred/predetermined user interface. The tag can be numerical or categorical, such as (a)-(e) in Table 1.

In some embodiments, the tag is added, on the fly, after the question format is determined by the system. In other words, once the question format is determined, an appropriate tag is associated to the question, before the question is displayed to a user. Therefore, when the question is used or re-used, no repeat determination of the question format is required. In some aspects, therefore, a “cache” index or question database is used, that stores such tags. User Input Analysis and Follow-up Questions

Upon receiving an input from a user in response to the presentation of the question, in some embodiments, the system sends the input back to the provider. In some embodiments, the input is analyzed in situ, in an “analysis engine” as shown in FIG. 1. The analysis engine is configured to process the input, optionally along with other information from the business process database.

In some embodiments, upon analysis of the user's input, a follow-up question is presented to the user. The presentation of the follow-up question can take the same process as described above, enabling collection of more input from the user.

For instance, if a patient indicates that a dose of medication is missed, the system asks what the medication is, and/or for how long it has been missed. In case the missed dose poses danger to the patient, an emergency alert is automatically sent to a suitable healthcare service provider or emergency response team. In another example, the patient indicates that he is suffering high body temperature or any other condition requiring urgent medical attention, an emergency alert is automatically sent.

### Notification Initiated User Communication

Also provided, in some embodiments, is a method to initiate communication with a user through a push notification. In the conventional technology, when a notification (e.g., an invitation for a user to conduct a survey or answer a question) is pushed to a user's computing device, the server keeps the computer process, which sends out the notification and awaits a response, until a response is received. When the notification is pushed to hundreds or even millions of user devices, it becomes expensive to keep all these computer processes alive, which takes memory space and processor time.

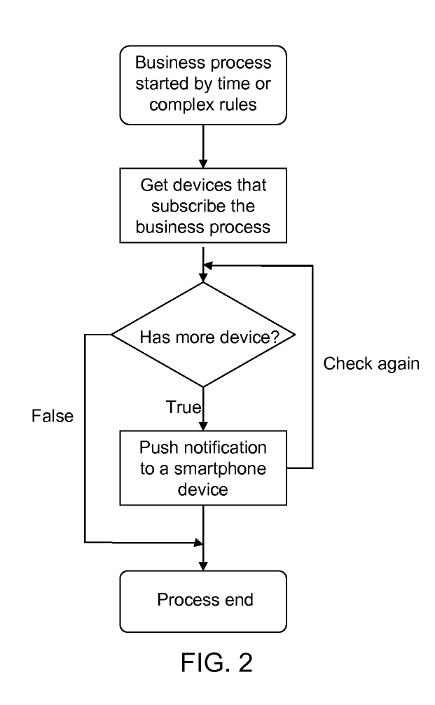

Provided, in one embodiment of the present disclosure, is a method that optimize a notification-initiated communication process. As illustrated in FIG. 2, the system determines the time to send a push notification and the content of the notification. The time and content, in one embodiment, are determined by user subscription, availability of the content, or business rules.

In some embodiments, the push notification is initiated by a “business process trigger.” A business process trigger can be defined in a business process definition, and customizable by a service provider. It can be a simple time based trigger, or a trigger based on an intelligent business rule. For a newly discharged patient from a hospital, a process trigger can be defined as twice daily to prompt the patient to measure his temperature.

In some embodiments, the business process trigger is determined from analysis of collected user input data. For example, if a patient's temperature is over 101 degree, or if a patient's temperature is over 100 degree for 3 consecutive days, it can trigger a process and notify the patient to call his doctor office.

The business process trigger can rely on both a business process engine and a data analysis engine. The data analysis engine analyzes real-time and/or historic data collected by business processes, and match its result with pre-configured complex trigger rule. When the trigger rule is matched, it will start a notification process.

The system is also configured to identify end-user computing devices (e.g., a mobile phone) to which the system sends the notification.

After sending the notification to identified end-user computing devices, the system then terminates the process that sends the notification. In other words, the system does not keep the processes alive to await responses from the users.

Upon an input from a user that responds to the push notification, then, the system initiates a new process to receive and process the input.

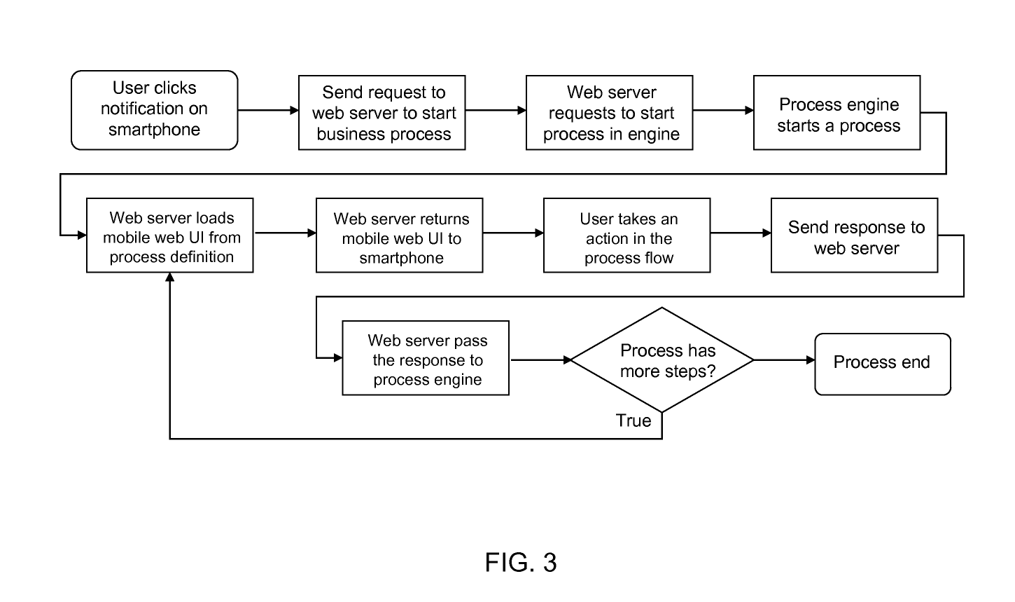

An example workflow is provided in FIG. 3 that illustrates this process. At a first step, when a user clicks on a notification on an end user computing device, such as a mobile phone, the end user computing device sends a request to a system of the present disclosure (e.g., a web server) to start an interactive content-driven communication process. At that point, the web server initiates the process engine, which retrieves a suitable question or notification from a question database (e.g., a business process database).

The process engine is able to process the retrieved question and determine its format, and then selects a suitable, pre-determined, user interface. With the selected user interface, the system is able to receive an input from the user as an answer. The answer is then fed to the analysis engine, which determines the meaning of the answer, and whether certain action needs to be taken, such as whether a further question is needed. Accordingly, the process may end, or start a new question/answer cycle.

It is apparent that such a process is relatively heavy, involving many steps and determinations. Therefore, the present technology, which is able to avoid keeping the process alive unnecessarily when no user input is detected, can greatly enhance the efficiency of the system. In other words, the system only re-initiates the process, after the system sends out push notification to a large amount of users, when a user responds.

### Computer Network

Embodiments can include program products comprising non-transitory machine-readable storage media for carrying or having machine-executable instructions or data structures stored thereon. Such machine-readable media may be any available media that may be accessed by a general purpose or special purpose computer or other machine with a processor. By way of example, such machine-readable storage media may comprise RAM, ROM, EPROM, EEPROM, CD-ROM or other optical disk storage, magnetic disk storage or other magnetic storage devices, or any other medium which may be used to store desired program code in the form of machine-executable instructions or data structures and which may be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the present invention have been described in the general context of method steps which may be implemented in one embodiment by a program product including machine-executable instructions, such as program code, for example in the form of program modules executed by machines in networked environments. Generally, program modules include routines, programs, logics, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present invention may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the invention may also be practiced in distributed and cloud computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

It should be noted that although the discussions herein may refer to a specific order and composition of method steps, it is understood that the order of these steps may differ from what is described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

Unless otherwise defined, all technical and scientific terms used herein have the same meaning as commonly understood by one of ordinary skill in the art to which this invention belongs.

The inventions illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed.

Thus, it should be understood that although the present invention has been specifically disclosed by preferred embodiments and optional features, modification, improvement and variation of the inventions embodied therein herein disclosed may be resorted to by those skilled in the art, and that such modifications, improvements and variations are considered to be within the scope of this invention. The materials, methods, and examples provided here are representative of preferred embodiments, are exemplary, and are not intended as limitations on the scope of the invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

In addition, where features or aspects of the invention are described in terms of Markush groups, those skilled in the art will recognize that the invention is also thereby described in terms of any individual member or subgroup of members of the Markush group.

All publications, patent applications, patents, and other references mentioned herein are expressly incorporated by reference in their entirety, to the same extent as if each were incorporated by reference individually. In case of conflict, the present specification, including definitions, will control.

It is to be understood that while the disclosure has been described in conjunction with the above embodiments, that the foregoing description and examples are intended to illustrate and not limit the scope of the disclosure. Other aspects, advantages and modifications within the scope of the disclosure will be apparent to those skilled in the art to which the disclosure pertains.

1. A computing device comprising a processor and program code which, when executed by the processor, configures the device to:
retrieve a question and expected answer from a question database;
determine a question format based on the content of the question and the expected answer, wherein the question format is selected from the group consisting of (a) a question requiring a text input, (b) a polar question, (c) a multiple choice question with a single choice, (d) a multiple choice question with one or more choices, and (e) a referral question that loads a selected computer program;
select a predefined user interface based on the determined question format;
display the question with the selected user interface on a screen; and
receive an input from a user as answer to the question.

2. The device of claim 1, wherein the selected user interface comprises a text input area if the determined question format is (a).

3. The device of claim 1, wherein the selected user interface comprises a button for a positive answer and a button for a negative answer if the determined question format is (b).

4. The device of claim 1, wherein the selected user interface comprises a button for each of the choices if the determined question format is (c).

5. The device of claim 1, wherein the selected user interface comprises a checkbox for each of the choices and a confirmation button if the determined question format is (d).

6. The device of claim 1, wherein the selected user interface comprises one or more referral link if the determined question format is (e).

7. The device of claim 6, wherein the referral links each is directed to a program selected from the group consisting of voice call to a phone number, a web address, a multimedia file, a navigation or mapping program, and a social networking program.

8. The device of claim 1, wherein the selection of a predefined user interface further takes into consideration of the user's information selected from one or more of age, gender, locale, healthcare or condition.

9. The device of claim 1, wherein, following determination of the question format, the system is further configured to generate a tag for the question that corresponds to the question format or corresponds to the selected user interface.

10. The device of claim 9, wherein the system is further configured to store the tag.

11. The device of claim 9, wherein the generation of the tag is after the selection of the user interface.

12. The device of claim 9, wherein the generation of the tag is before the selection of the user interface.

13. The device of claim 12, wherein the selection of the user interface is based on the tag.

14. The device of claim 1, wherein the program code further configures the device to, prior to displaying the question on the screen, send an alert to the user, wherein the alert prompts the user to receive the question.

15. The device of claim 14, wherein the program code further configures the device to terminate the computer process on the device for displaying the question and receiving the input.

16. The device of claim 15, wherein the program code further configures the device to reinitiate a computer process, upon the user's response to receive the question, to display the question and receive the input from the user.

17. A method for conducting a survey, comprising:
retrieving, on a computing device, a question and expected answer from a question database;
determining a question format based on the content of the question and the expected answer, wherein the question format is selected from the group consisting of (a) a question requiring a text input, (b) a polar question, (c) a multiple choice question with a single choice, (d) a multiple choice question with one or more choices, and (e) a referral question that loads a selected computer program;
selecting a predefined user interface based on the determined question format;
displaying the question with the selected user interface on a screen; and
receiving an input from a user as answer to the question.
